(19) United States
(12) Patent Application Publication
(10) Pub. No.: US 2020/0049075 A1
(43) Pub. Date: Feb. 13, 2020

(54) ACOUSTIC PANEL AND METHOD FOR MAKING THE SAME

(71) Applicant: General Electric Company, Schenectady, NY (US)

(72) Inventor: Egbert Geertsema, Cincinnati, OH (US)

(73) Assignee: General Electric Company, Schenectady, NY (US)

(21) Appl. No.: 16/059,338

(22) Filed: Aug. 9, 2018

(51) Int. Cl. F02C 7/24; B33Y 80/00; F02K 1/82; G10K 11/172

(52) U.S. Cl. CPC F02C 7/24; B33Y 80/00; B32B 3/12; G10K 11/172; F02K 1/827

(57) ABSTRACT

An acoustic panel comprises a face sheet comprising a plurality of openings; a back sheet opposite to the face sheet; and an intermediate layer comprising a plurality of cells each comprising a cavity and a plurality of walls extending between the face sheet and the back sheet and surrounding the cavity. The plurality of walls can comprise at least one and possibly a plurality of slots for drainage. A method for making the acoustic panel is also described.

### BACKGROUND

The present embodiments generally relate to an acoustic panel and a method for making the acoustic panel. More particularly, the embodiments relate to an acoustic panel useful for acoustic or noise abatement purposes. For example acoustic or noise abatement purposes include, but are not limited to, turbomachinery, such as but not limited to, an engine and a method for making the acoustic panel.

To prevent a damage from, for example, a freeze-thaw cycle, acoustic panels may typically include slots to drain liquid. The liquid can be water and/or fuel, either for use with the device having the panels or from an exterior source from the device. In some instances, about 30% of the area of the acoustic panel can be provided with drainage slots.

However, drainage slots in the acoustic panel may have a negative effect on the desired acoustic or noise attenuation. These slots may reduce the acoustic or noise attenuation when the acoustic panel has a large amount of drainage slots that create “openings” which may not abate acoustics or noises in the device.

In addition, acoustic panel drainage slots may be provided in a default or standard pattern. These default patterns may not be able to support drainage.

### BRIEF DESCRIPTION

In one aspect, embodiments of the present embodiment relate to an acoustic panel comprising: a face sheet comprising a plurality of openings; a back sheet opposite to the face sheet; and an intermediate layer comprising a plurality of cells each comprising a cavity and a plurality of walls extending between the face sheet and the back sheet and surrounding the cavity, the plurality of walls being provided by additive manufacturing and comprising a plurality of slots all supporting drainage of liquid.

In another aspect, embodiments of the present embodiment relate to a method for making an acoustic panel, comprising: providing a face sheet comprising a plurality of openings; providing a back sheet opposite to the face sheet; and providing an intermediate layer comprising a plurality of cells each comprising a cavity and a plurality of walls extending between the face sheet and the back sheet and surrounding the cavity, the plurality of walls being provided by additive manufacturing and comprising a plurality of slots all supporting drainage of liquid.

Optionally, the acoustic panel is useful in an engine. Optionally, the acoustic panel is useful in an aero engine. Optionally, the acoustic panel is useful in an aircraft engine. Optionally, the plurality of cavities is in fluid communication with the plurality of openings. Optionally, the plurality of slots comprises a plurality of sets of slots and the slots in each of the plurality of sets of slots are in fluid communication with each other and are aligned with a direction of the drainage of the liquid. Optionally, the slots in each of the plurality of sets of slots are aligned substantially parallel with the direction of the drainage of the liquid. Optionally, one of the plurality of cells comprises two slots in corresponding walls thereof. Optionally, one of the plurality of cells comprises at least two slots in corresponding walls thereof. Optionally, one of the plurality of cells has a cross-section of a polygon.

### BRIEF DESCRIPTION OF THE DRAWINGS

These and other features, aspects, and advantages of the present embodiment will become better understood when the following detailed description is read with reference to the accompanying drawings in which like characters represent like parts throughout the drawings, wherein:

FIG. 1 is a schematic view of an exemplary application of an acoustic panel in accordance with a non-limiting engine embodiment of the present embodiment.

FIG. 2 illustrates a schematic partially cutaway perspective view of an acoustic panel shown in FIG. 1.

FIG. 3 illustrates a schematic cross-sectional view of a portion of an intermediate layer of the acoustic panel of FIG. 2.

FIG. 4 is a schematic flow chart of a method for making an acoustic panel in accordance with embodiments of the present embodiment.

Unless otherwise indicated, the drawings provided herein are meant to illustrate features of embodiments of this embodiment. These features are believed to be applicable in a wide variety of systems comprising one or more embodiments of this embodiment. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value.

As used herein, the terms “circumferential” and “circumferentially” refer to directions and orientations that extend arcuately about the centerline of the engine.

The term “coupled”, or “connected”, as used herein, is defined as coupled, or connected, directly or indirectly.

Embodiments herein relate to acoustic panels for acoustic or noise abatement purposes. Acoustic panels find exemplary and non-limiting applications where sound quality improvement and/or abatement are desirable. For example, and in no way limiting of the embodiments, acoustic panels may be used in offices, recording studies, homes, theaters, museums, restaurants, and other facilities where acoustics, noise quality and levels are a concern.

Moreover, and in no way limiting of the embodiments, acoustic panels may be used on or in machines where acoustics and noise abatement are needed or desired. These applications may include but are not limited to, manufacturing machinery, cooling and heating devices, and powerplants including those with turbomachinery, such as gas turbines, steam turbines, generators, and reciprocating engines. Acoustic panels are often useful to manage acoustics and sound quality on turbomachines, such as aero turbomachines and/or aircraft engines.

Moreover, the acoustic panels described herein comprise slots for drainage of liquid, such as water and/or fuel. The liquid may be present in the panels from openings in a face sheet of the panel. These openings are provided to facilitate drainage of liquid that is used in the operation of the device, or originates outside of the device. Regardless of the source of the liquid in the panel, the slots permit drainage of the liquid therefrom. Additionally, the slots in the acoustic panels can be provided during manufacture of the panels. The manufacturing of the panels and the formation of the slots can be by any suitable process, such as but not limited to, machining, additive manufacturing, 3D printing, forming during the molding or assembly.

The configuration of the acoustic panel herein can facilitate reduction of attenuation therein by reducing the number of slots in the acoustic panel. For example, slots that do not drain liquid can be eliminated. Additionally, the s acoustic panel configuration and the method for making the acoustic panel can increase the attenuation of the acoustic panel, increasing noise margins. Thus, it is possible to achieve desired noise levels with an acoustic panel having a reduced acoustic area and/or length, shorter duct lengths, lighter nacelle, reduced scrubbing drag, and/or lower cost, among other benefits, compared to other panels.

As used herein, the terms “face”, “back”, “intermediate”, “front”, “forward”, “aft”, “upper”, “lower”, etc., may be used in reference to the perspective of the installation and orientation of the components in the drawings, and therefore are relative terms that indicate the construction, installation and use of the components. However, it is within the scope of the embodiment that the components could be installed and/or used that markedly differs from the components shown in the drawings, or installed at other points of the engine.

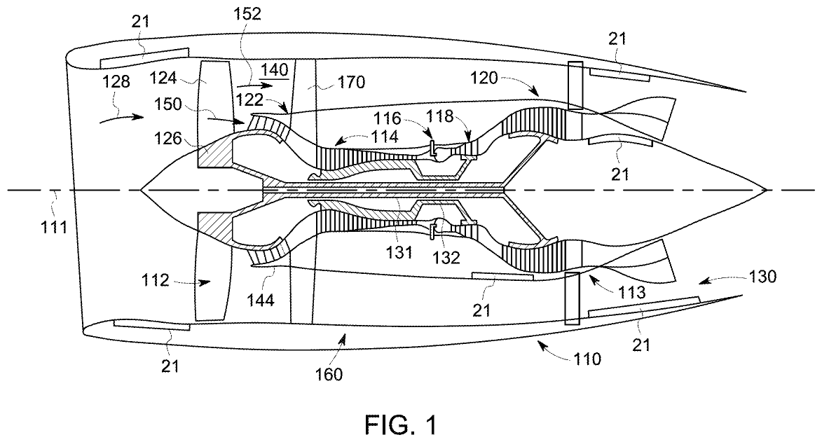

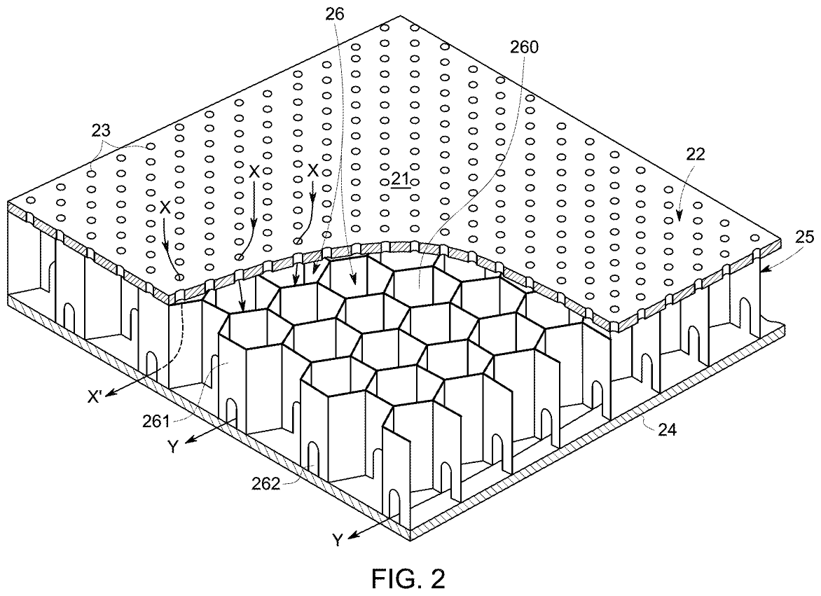

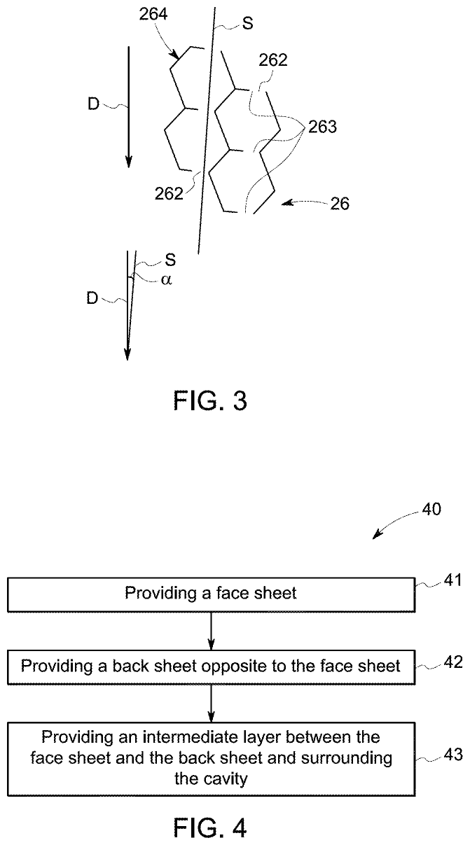

The acoustic panel 21, as embodied herein will be described with respect to FIGS. 2 and 3. FIG. 1 illustrates one exemplary and non-limiting application of the acoustic panel as per the embodiments herein, for example and in no way limiting in turbomachine, such as an engine. FIG. 1 application is merely exemplary, and other applications are within the scope of this instant application and claims.

FIG. 1 is a cross-sectional schematic illustration of an exemplary gas turbine engine assembly 110 having a longitudinal axis 111. Gas turbine engine assembly 110 includes a fan assembly 112 and a core gas turbine engine 113. Core gas turbine engine 113 includes a high-pressure compressor 114, a combustor 116, and a high-pressure turbine 118. In the exemplary embodiment, gas turbine engine assembly 110 also includes a low-pressure turbine 120, and a multi-stage booster compressor 122, and a splitter 144 that substantially circumscribes booster 122.

Fan assembly 112 includes an array of fan blades 124 extending radially outward from a rotor disk 126. Gas turbine engine assembly 110 has an intake side 128 and an exhaust side 130. Fan assembly 112, booster 122, and turbine 120 are coupled together by a first rotor shaft 131, and compressor 114 and turbine 118 are coupled together by a second rotor shaft 132.

In operation, air flows through fan assembly 112 and a first portion 150 of the airflow is channeled through booster 122. The compressed air that is discharged from booster 122 is channeled through compressor 114 wherein the airflow is further compressed and delivered to combustor 116. Hot products of combustion (not shown in FIG. 1) from combustor 116 are utilized to drive turbines 118 and 120, and turbine 120 is utilized to drive fan assembly 112 and booster 122 by way of shaft 131. Gas turbine engine assembly 110 is operable at a range of operating conditions between design operating conditions and off-design operating conditions.

A second portion 152 of the airflow discharged from fan assembly 112 is channeled through a bypass duct 140 to bypass a portion of the airflow from fan assembly 112 around the core gas turbine engine 113. More specifically, bypass duct 140 extends between a fan casing 142 and splitter 144. Accordingly, a first portion 150 of the airflow from fan assembly 112 is channeled through booster 122 and then into compressor 114 as described above and a second portion 152 of the airflow from fan assembly 112 is channeled through bypass duct 140 to provide thrust for an aircraft, for example. Gas turbine engine assembly 110 also includes a fan frame assembly 160 to provide structural support for fan assembly 112 and is also utilized to couple fan assembly 112 to core gas turbine engine 113.

Fan frame assembly 160 includes a plurality of outlet guide vanes 170 that typically extend substantially radially, between a radially-outer mounting flange and a radially-inner mounting flange, and are circumferentially-spaced within bypass duct 140. Guide vanes 170 serve to turn the airflow downstream from rotating blades such as fan blades 124.

To reduce noise emanating anywhere in the engine 110, such as but not limited to, in the overall fan frame assembly 160, portions thereof may be lined with noise attenuation panels, which are in the form of an acoustic panel 21, as per the embodiments herein and described with reference to FIGS. 2 and 3. As shown in FIG. 1, the engine 110 may have its fan frame assembly 160 lined with the acoustic panels at but not limited to one or more of regions proximate the fan duct, a thrust reversal unit, the inner wall of the its fan frame assembly 160 and/or the inner fan duct wall.

The acoustic panel 21 can be applied anywhere in the engine where noise attenuation is needed. The acoustic panel 21 can be configured in an arcuate form, for example, having a double curvature configuration. This configuration is embodied in structural parts of the engine 110 illustrated in FIG. 1. In some embodiments, the acoustic panel 21 may be also placed directly on the inner and outer surfaces of the inner and outer walls of the primary nozzle (not illustrated), and/or on the bifurcations (areas where the acoustic panel 21 are located in FIG. 1). The acoustic panel 21 may be a single feature or provided in combination extending circumferentially around the nacelle structure 113.

Referring now to FIGS. 2 and 3, a noise attenuation or acoustic panel 21 is illustrated. The acoustic panel 21 illustrated comprises a face sheet 22 comprising a plurality of openings 23, a back sheet 24 opposite to the face sheet 22, and a cellular intermediate layer 25 comprising a plurality of cells 26. Each cell 26 comprises a cavity 260 and a plurality of walls 261 extending between the face sheet 22 and the back sheet 24 and surrounding the cavity 260. The plurality of walls 261 can be provided by any appropriate manufacturing process in the formation of the acoustic panel 21. One such non-limiting manufacturing process is additive manufacturing. The plurality of walls comprises a plurality of slots 262, through which liquids can drain, as described hereinafter.

The plurality of openings 23 in the face sheet 23 provide fluid communication between the cells 26 of the cellular intermediate layer 25 and the front face of the face sheet 22. Fluid can pass through one or more of the plurality of openings 23 in the face sheet 22 and enter into the cells 26 of the cellular intermediate layer 25.

The plurality of openings 23 of the face sheet 22 of the acoustic panel 21 have any cross-section (such as the circular cross-section as illustrated in FIG. 2), and can be formed with uniform or non-uniform sizes over the surface of the face sheet 22. Also, the plurality of openings 23 of the face sheet 22 of the acoustic panel 21 can be uniformly or non-uniformly distributed over the surface of the face sheet 22.

To provide for noise attenuation over a wide range of frequencies, the geometry and distribution of one or more of the plurality of openings 23 may be modified. For example and not limiting of the embodiments, one or more of the plurality of openings 23 may be positioned as an array of openings, and with an opening size and shape that vary over the face sheet 22. An opening size variation may provide differentiated attenuating performance across the acoustic panel 21.

The plurality of openings 23 may be produced by any appropriate manufacturing process. Exemplary and non-limiting processes include at least one of additive manufacturing, 3D printing, mechanical drilling, laser beam drilling, and/or electron beam drilling. The plurality of openings 23 may be produced prior to the face sheet 22, the cellular intermediate layer 25 and the back sheet 24 are joined. However, depending on the manufacturing process, the formation of the plurality of openings may at any appropriate.

The face sheet 22 is coupled to an upper face of the cellular intermediate layer 25. The coupling can be by an adhesive, by the manufacturing processing or other suitable coupling system. The back sheet 24 may be unperforated and made from an impermeable sheet material. The back sheet 24 may also be connected by be by an adhesive, by the manufacturing processing or other suitable coupling system to a lower face of the cellular intermediate layer 25. The cells 26 of the cellular intermediate layer 25 are open-ended and juxtaposed. Also, the plurality of cavities 260 defined thereby may be in fluid communication with the plurality of openings 23, as illustrated in FIG. 2 by arrows X.

In other exemplary non-limiting embodiments, one or more of the plurality of cells 26 may have a polygonal cross-section 264. For example, and not intending to limit the embodiments in any way, one or more of the plurality of cells 26 may have hexagonal cross sections to provide a honeycomb configuration of the intermediate layer 25. Alternatively, the one or more of the plurality of cells 26 may have juxtaposed cells of other polygonal cross-sections other than but including hexagonal positioned in the acoustic panel, with cells of different sizes and shapes adjacent each other. For example, one or more of the plurality of cells 26 may be rectangular, one or more of the plurality of cells 26 may be triangular, one or more of the plurality of cells 26 may be hexagonal, one or more of the plurality of cells 26 may be octagonal, and so forth. In essence, the configuration and polygonal shapes of the one or more of the plurality of cells 26 can take numerous and non-limiting shapes, arrangements, and formations.

In a non-limiting embodiment, the slots 262 in the walls 261 can allow fluids, such as water and/or fuel, to drain from the acoustic panel 21, in the direction of arrows Y. Following the fluid flow, the fluid enters the acoustic panel 21 through the plurality of holes 23 in the face sheet 22, as shown by arrow X. As the fluid enters the intermediate layer 25 it enters one of the plurality of cells 26. From that cell 26 to which the fluid enters, it can then flow through slots 262 as illustrated in FIG. 2. As illustrated, the slots 262 can be arranged flow fluid from one cell 262 to another cell 26, while the flow can continue in the direction of arrows Y to drain the fluid out of the acoustic panel 21. Some of the cells 26 may comprise only one slot 262 where that cell is proximate a terminus edge of the acoustic panel 21, so as the fluid flow (Arrow X′) needs to only flow into one cell 26 to exit a slot 262 to the outside of the acoustic panel 21. Others of the cells 26 may comprise two slots, thus fluid may enter the cell 26 from one slot 262 at one side of the cell 26 and exit the cell 26 from the other side's slot 262. This fluid flow is best illustrated at arrow Y at the right side of the acoustic panel 21 in FIG. 2. Also, as desired and necessitated by the acoustic panel 21 configuration, more than two slots 262 may be provided in a cell 26 depending on the orientation of the acoustic panel 21 and the desired direction of the fluid flow from the acoustic panel 21.

As illustrated in FIG. 3, which is a top view of a plurality of cells 26 in the intermediate layer 25, the plurality of slots 262 may comprise a plurality of slot sets (hereinafter “sets of slots”) 263. The slots 262 in each of the plurality of sets of slots 263 are in fluid communication with each other. These plurality of sets of slots 263 can be aligned in a direction D of the drainage of the liquid. In some embodiments, the slots 262 in each of the plurality of sets of slots 263 are directedly aligned with the direction D of the drainage of the liquid.

Alternatively, the plurality of sets of slots 263 can be aligned with line S, which connects slots 262 of two adjacent cells 26 in one set of slots 263. Line S defines an acute angle α with respect to the direction D of the drainage of the liquid.

Referring to FIG. 4 a method 40 for making an acoustic panel 21. The exemplary method comprises Step 41, providing/forming a face sheet 22 comprising a plurality of openings; Step 42, providing/forming a back sheet opposite to the face sheet 22; and Step 43, providing/forming an intermediate layer 25, where the intermediate layer 25 comprises a plurality of cells 26 each comprising a cavity and a plurality of walls extending between the face sheet 22 and the back sheet 24 and surrounding the cavity 26. The plurality of walls comprising a plurality of slots 262 for drainage of fluid from the cells 26. In Step 44 the face sheet 22, the back sheet 24, and the intermediate layer 25 are joined to form the acoustic panel 21.

In an alternate method, Steps 41, 42 and 43 may be simultaneously provided/formed in a contemporaneously to form the acoustic panel 21. Exemplary simultaneous methods include, but are not limited to, forming the acoustic panel 21 by molding, 3D printing, additive manufacturing, and the similar simultaneous manufacturing processes.

This written description uses examples to disclose the embodiments, including the best mode, and also to enable any person skilled in the art to practice the embodiments, including making and using any devices or systems and performing any incorporated methods. The patentable scope of the embodiment is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An acoustic panel comprising:
a face sheet comprising a plurality of openings;
a back sheet opposite to the face sheet; and
an intermediate layer comprising a plurality of cells, each of the plurality of cells defining a cavity and a plurality of walls extending between the face sheet and the back sheet and surrounding the cavity, at least one of the plurality of walls comprising at least one slot for drainage of liquid from the cavity.

2. The acoustic panel of claim 1, wherein each cavity is in fluid communication with at least one of the at least one slot for drainage of liquid from the cavity.

3. The acoustic panel of claim 1, wherein at least one slot in at least one of the plurality of walls comprises a plurality of slots for drainage of liquid from the cavity.

4. The acoustic panel of claim 3, wherein the plurality of slots for drainage of liquid from the cavity comprises a plurality of slot sets and each of the slots in each of the plurality of slot sets in fluid communication with each other and aligned with a direction of drainage.

5. The acoustic panel of claim 4, wherein the slots for drainage of liquid from the cavity in each of the plurality of slot sets are aligned with the direction of drainage.

6. The acoustic panel of claim 1, wherein at least one of the plurality of cells comprises two slots for drainage of liquid from the cavity in a wall of the plurality of walls.

7. The acoustic panel of claim 1, wherein at least one of the plurality of cells comprises two or more slots for drainage of liquid from the cavity in a wall of the plurality of walls.

8. The acoustic panel of claim 1, wherein at least one of the plurality of cells comprises a polygonal cross-section.

9. A method for making an acoustic panel, the acoustic panel comprising a face sheet comprising a plurality of openings; a back sheet opposite to the face sheet; and an intermediate layer comprising a plurality of cells, each of the plurality of cells defining a cavity and a plurality of walls;
the method comprising:
joining the intermediate layer between the face sheet and the back sheet,
defining at least one slot in at least one of the plurality of walls for drainage of liquid from the cavity;
surrounding the face sheet and the back sheet over the cavity, so each of the at least one slot can drain liquid from the cavity.

10. The method of claim 9, wherein each cavity is in fluid communication with at least one of the at least one slot in at least one of the plurality of walls for drainage of liquid from the cavity.

11. The method of claim 9, wherein the plurality of slots in at least one of the plurality of walls for drainage of liquid from the cavity comprises a plurality of sets of slots and each of the slot sets in each of the plurality of sets are in fluid communication with each other and aligned with a direction of drainage.

12. The method of claim 11, wherein the slots in at least one of the plurality of walls for drainage of liquid from the cavity in at least one of the plurality of walls for drainage of liquid from the cavity in each of the plurality of slot sets are aligned with the direction of drainage.

13. The method of claim 9, wherein at least one of the plurality of cells comprises two slots in at least one of the plurality of walls for drainage of liquid from the cavity in a wall of the plurality of walls.

14. The method of claim 9, wherein at least one of the plurality of cells comprises two or more slots in at least one of the plurality of walls for drainage of liquid from the cavity in corresponding walls thereof.

15. The method of claim 9, wherein at least one of the plurality of cells comprises a polygonal cross-section.

16. The method of claim 9, wherein each cavity is in fluid communication with at least one of the at least one slot in at least one of the plurality of walls for drainage of liquid from the cavity; the plurality of slots in at least one of the plurality of walls for drainage of liquid from the cavity comprises a plurality of sets of slots and each of the slot sets in each of the plurality of sets are in fluid communication with each other and aligned with a direction of drainage; and wherein the slots in at least one of the plurality of walls for drainage of liquid from the cavity in at least one of the plurality of walls for drainage of liquid from the cavity in each of the plurality of slot sets are aligned with the direction of drainage.

17. An acoustic panel comprising:
a face sheet comprising a plurality of openings;
a back sheet opposite to the face sheet; and
an intermediate layer comprising a plurality of cells, each of the plurality of cells defining a cavity and a plurality of walls extending between the face sheet and the back sheet and surrounding the cavity, at least one of the plurality of walls comprising at least one slot for drainage of liquid from the cavity, wherein each cavity is in fluid communication with at least one of the at least one slot for drainage of liquid from the cavity, wherein at least one slot in at least one of the plurality of walls comprises a plurality of slots for drainage of liquid from the cavity; and wherein the plurality of slots for drainage of liquid from the cavity comprises a plurality of slot sets and each of the slots in each of the plurality of slot sets in fluid communication with each other and aligned with a direction of drainage; and thus the slots for drainage of liquid from the cavity in each of the plurality of slot sets are aligned with the direction of drainage.

18. An acoustic panel of claim 17, wherein at least one of the plurality of cells comprises two slots for drainage of liquid from the cavity in a wall of the plurality of walls.

19. The acoustic panel of claim 17, wherein at least one of the plurality of cells comprises two or more slots for drainage of liquid from the cavity in a wall of the plurality of walls.

20. The acoustic panel of claim 17, wherein at least one of the plurality of cells comprises a polygonal cross-section.
